(19) United States
(12) Patent Application Publication
(10) Pub. No.: US 2026/0370151 A1
(43) Pub. Date: Nov. 19, 2026

(54) SWITCHING-MODE POWER SUPPLY AND CONTROL METHOD FOR EXTENDING VOLTAGE HOLD-UP TIME

(71) Applicant: Acbel Polytech Inc., Taipei City (TW)

(72) Inventors: Cheng-Hsiao Luo, Taipei City (TW); Zhe-Wei Cao, Taipei City (TW); I-Hsiu Lo, Taipei City (TW)

(21) Appl. No.: 19/390,883

(22) Filed: Nov. 17, 2025

(30) Foreign Application Priority Data
May 19, 2025 (TW) 114118698

(51) Int. Cl. H02M 3/335; H02M 3/00

(52) U.S. Cl. CPC H02M 3/33592; H02M 3/01; H02M 3/33573

(57) ABSTRACT

A switching-mode power supply and a control method for extending voltage hold-up time are provided. The control circuit of the switching-mode power supply determines whether an abnormal condition is present in the external power source and accordingly controls the conduction states of the input switching unit and the synchronous rectification unit of the LLC resonant conversion module. In response to the external power source is determined to be abnormal, the control circuit reduces the switching frequency of the input switching unit and the synchronous rectification unit, thereby increasing the voltage gain of the LLC resonant conversion module as the input voltage decreases. In response to the switching frequency is reduced to the minimum limit frequency, the control circuit maintains the switching frequency at the minimum limit frequency and instead extends the conduction time of the synchronous rectification unit to further increase the voltage gain as the input voltage decreases.

### CROSS-REFERENCE TO RELATED APPLICATION

This application claims priority to Taiwan Patent Application 114118698, filed May 19, 2025, which is incorporated herein by reference.

### TECHNICAL FIELD

The present application relates to a switching-mode power supply control and its control technology, particularly to a switching-mode power supply using an LLC resonant converter architecture and a control method for extending voltage hold-up time.

### BACKGROUND

Switching-mode power supplies (SMPS) have been widely applied as power supplies for various electronic products, such as cloud servers, edge servers, industrial computers, and notebook computers. Among various architectures, LLC resonant converters have become a widely adopted architecture in switching-mode power supply design due to their high conversion efficiency, which is attributed to their control characteristics that allow for Zero Voltage Switching (ZVS) and Zero Current Switching (ZCS).

The high performance and low loss characteristics of LLC resonant converters make them particularly suitable for applications requiring high power stability, such as server power supplies, industrial computers, and data centers. However, when there is a sudden drop in input voltage or grid abnormality, LLC resonant converters typically rely on the discharge of the input capacitor to maintain the output voltage. The output voltage hold-up time during this period directly affects whether the system can continue to supply power stably during a power outage.

To extend the hold-up time, one of the existing solutions is to increase the voltage gain by adjusting the parameters of the resonant inductor and/or resonant capacitor. However, this method not only leads to a decrease in the conversion efficiency of the LLC resonant converter but also causes the increase of the voltage stress and/or current stress on the resonant capacitor.

Another existing solution involves connecting an additional hold-up time extension circuit in parallel with the input capacitor to extend the output voltage hold-up time. However, due to the excessive volume of the hold-up time extension circuit, it not only increases the manufacturing cost of the LLC resonant converter but also constricts the layout space for the input capacitor, thereby limiting the available capacitor specifications in design.

Furthermore, in existing technologies, the control methods for LLC resonant converters commonly adopt reducing the switching frequency to increase gain, thereby extending the output voltage's hold-up time. However, when the switching frequency is further reduced to near or below the resonant frequency, if the secondary side synchronous rectification switch remains in a conducting state during periods of no energy transfer, current might flow in reverse through the synchronous rectification switch, and energy from the output capacitor could be fed back to the primary side via the transformer coupling path, which would conversely lead to a decrease in voltage gain.

### SUMMARY

The present application provides a switching-mode power supply and a control method capable of extending the voltage hold-up time, which can solve the issues mentioned in the prior art.

Embodiments of the present application disclose a switching-mode power supply adapted to generate operating power from an external power source for supplying to a load. The switching-mode power supply comprises an input capacitor and an LLC resonant conversion module. The LLC resonant conversion module comprises an input switching unit, a resonant unit, a transformer unit, a synchronous rectification unit, and a control circuit. The input switching unit is configured to receive DC power. The resonant unit is coupled to the input switching unit. The transformer unit has a primary winding and a secondary winding, wherein the primary winding is coupled to the resonant unit. The synchronous rectification unit is coupled to the secondary winding and configured to perform synchronous rectification in association with the input switching unit. The control circuit is coupled to the input switching unit and the synchronous rectification unit and configured to monitor an input voltage on the input capacitor to determine whether an abnormal condition is present in the external power source, and accordingly controls the conduction states of the input switching unit and the synchronous rectification unit. In response to the external power source being determined abnormal, the control circuit reduces the switching frequency of the input switching unit and the synchronous rectification unit, thereby increasing a voltage gain of the LLC resonant conversion module as the input voltage decreases. In response to the switching frequency being reduced to a minimum limit frequency, the control circuit maintains the switching frequency at the minimum limit frequency and instead extends the conduction time of the synchronous rectification unit, such that the voltage gain increases as the input voltage decreases.

Embodiments of the present application further disclose a control method for extending the voltage hold-up time of a switching-mode power supply, wherein the switching-mode power supply is adapted to generate an operating power from an external power source for supplying to a load, and comprises an LLC resonant conversion module. The control method comprises the following steps: monitoring an output voltage supplied to the load to calculate a target voltage gain; adjusting a switching frequency of first and second input control signals and first and second synchronous rectification control signals based on the target voltage gain, such that a voltage gain of the LLC resonant conversion module matches the target voltage gain, wherein the first and second input control signals are complementary to each other and are used to control operations of a plurality of input switching elements of the LLC resonant conversion module; the first and second synchronous rectification control signals are complementary to each other and are used to control operations of a plurality of synchronous rectification switching elements of the LLC resonant conversion module; determining whether an abnormal condition is present in the external power source based on an input voltage; in response to the external power source being determined abnormal, adjusting the switching frequency based on the input voltage, such that the voltage gain increases as the input voltage decreases; determining whether the switching frequency is lower than a resonant frequency and whether it has reached a minimum limit frequency below the resonant frequency; in response to the switching frequency being lower than the resonant frequency but not yet reaching the minimum limit frequency, reducing a duty cycle of the first synchronous rectification signal and the second synchronous rectification signal to a first duty cycle, wherein a corresponding enable period of the first duty cycle is an inverse of the resonant frequency; and in response to the switching frequency being reduced to a minimum limit frequency, maintaining the switching frequency at the minimum limit frequency, and advancing the rising edge trigger points of the first and second synchronous rectification control signals to extend the conduction time of the synchronous rectification switching elements.

### DESCRIPTION OF DRAWINGS

The accompanying drawings are included to provide a further understanding of the embodiments of the present application and the prior art, and are incorporated in and constitute a part of this specification. The drawings illustrate embodiments of the present application and, together with the description, serve to explain the principles of the present application. It should be understood that the drawings are provided for purposes of illustration only and are not intended to limit the scope of the present application. Other drawings may be obtained by those skilled in the art without undue experimentation.

FIG. 1 is a schematic circuit block diagram of a switching-mode power supply according to some embodiments of the present application;

FIGS. 2A and 2B are schematic circuit architecture diagrams of an LLC resonant conversion module according to different embodiments of FIG. 1;

FIG. 3 is a schematic power sequence diagram of a switching-mode power supply;

FIG. 4 is a schematic power sequence diagram of a switching-mode power supply using a control method according to some embodiments of the present application;

FIGS. 5A-5D are schematic control signal timing sequence diagrams of a switching-mode power supply according to some embodiments of the present application in different operating modes;

FIGS. 6A-6C are schematic control signal timing sequence diagrams of a switching-mode power supply according to yet other embodiments of the present application in different operating modes;

FIG. 7 is a flowchart of a control method for a switching-mode power supply according to different embodiments of the present application;

FIGS. 8A-8E are schematic circuit architecture diagrams of an LLC resonant conversion module according to different embodiments of the present application; and

### DETAILED DESCRIPTION

The present disclosure will now be described in the following embodiments with reference to the drawings. The following descriptions of various embodiments of this invention are presented herein for purpose of illustration and giving examples only. It is not intended to be exhaustive or to be limited to the precise form disclosed. These example embodiments are just that – examples – and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail – it is impracticable to list every possible variation for every feature described herein. The language of the claims should be referenced in determining the requirements of the invention. In the drawings, the size and relative sizes of components may be exaggerated for clarity. Like numbers refer to like elements throughout.

For consistency and ease of understanding, like reference numerals are used in the exemplary drawings to designate like features (although in certain examples such labeling may be omitted for clarity). The features of different embodiments may vary in other respects; accordingly, the embodiments should not be construed as limited to the particular features depicted in the drawings.

It will be understood that, although the terms first, second, third etc. may be used herein to describe various elements, components, regions, layers, or steps, these elements, components, regions, layers, and/or steps should not be limited by these terms. Unless the context indicates otherwise, these terms are only used to distinguish one element, component, region, layer, or step from another element, component, region, or step, for example as a naming convention. Thus, a first element, component, region, layer, or step discussed below in one section of the specification could be termed a second element, component, region, layer, or step in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

It will be further understood that the terms "comprises" and/or "comprising," or "includes" and/or "including" when used in this specification, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being "connected" or "coupled" to or “on” another element, it can be directly connected or coupled to or on the other element or intervening elements may be present. In contrast, when an element is referred to as being "directly connected" or "directly coupled" to another element, there are no intervening elements present. Other words used to describe the relationship between elements should be interpreted in a like fashion (e.g., "between" versus "directly between," "adjacent" versus "directly adjacent," etc.). However, the term “contact,” as used herein refers to direct connection (i.e., touching) unless the context indicates otherwise.

Unless otherwise indicated, all numerical values disclosed for the embodiments of the present application are to be understood as modified by the term “about,” i.e., they encompass permissible variations that may arise from measurement uncertainty, process tolerances, or material selection. The magnitude of such variations is that which would not materially alter the structure, properties, or performance described. By way of non-limiting example, the variation may be within ±10% of the stated value. The scope of such variations will be apparent to a person of ordinary skill in the art.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Embodiments may be described, and illustrated in the drawings, in terms of functional blocks, units and/or modules. Those skilled in the art will appreciate that these blocks, units and/or modules are physically implemented by electronic (or optical) circuits such as logic circuits, discrete components, analog circuits, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules. Further, the blocks, units and/or modules of the various embodiments may be physically combined into more complex blocks, units and/or modules.

If any terms in this application conflict with terms used in any application(s) from which this application claims priority, or terms incorporated by reference into this application or the application(s) from which this application claims priority, a construction based on the terms as used or defined in this application should be applied.

It should be noted that, the following description of various embodiments of the present disclosure is described herein in order to clearly illustrate the inventive features of the present disclosure. However, it is not intended that various embodiments can only be implemented alone. Rather, it is contemplated that various of the different embodiments can be and are intended to be used together in a final product, and can be combined in various ways to achieve various final products. Thus, people having ordinary skill in the art may combine the possible embodiments together or replace the components/modules between the different embodiments according to design requirements. The embodiments taught herein are not limited to the form described in the following examples, any possible replacement and arrangement between the various embodiments are included.

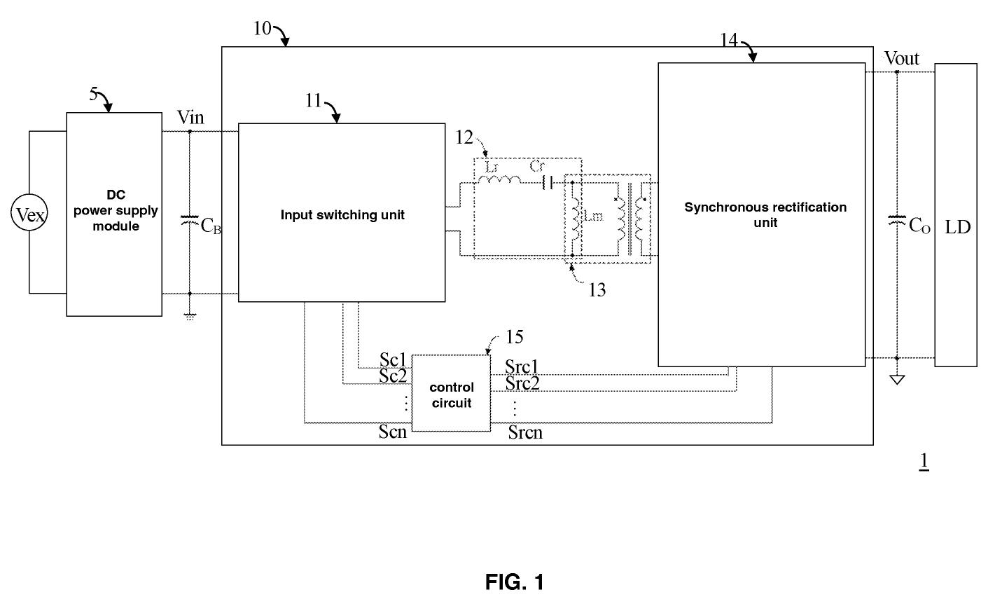

FIG. 1 is a schematic circuit block diagram of a switching-mode power supply according to some embodiments of the present application. Please refer to FIG. 1, the switching-mode power supply 1 is adapted to generate an operating power from an external power source Vex for supplying to a load LD, and mainly comprises a DC power supply module 5, an input capacitor C_{B}, an LLC resonant conversion module 10, and an output capacitor C_{O}. The load LD can be, for example, various types of servers (such as cloud servers, edge servers, and the like.), industrial computers, or notebook computers, and the present application is not limited thereto.

In the present embodiment, the external power source Vex received by the switching-mode power supply 1 can be an AC power source or a DC power source, and the present application is not limited thereto. In embodiments where the external power source Vex is a DC power source, the DC power supply module 5 can also be omitted from the switching-mode power supply 1.

The DC power supply module 5 can be an AC-DC converter or a DC-DC converter used to generate input power based on the external power source Vex. For example, the DC power supply module 5 can be an AC-DC converter that comprises a full-bridge rectification unit and a power factor correction unit, wherein the power factor correction unit can be, but is not limited to, a semi-bridgeless PFC, an interleaving PFC, a totem pole PFC, or a simple power factor corrector that only contains an energy storage inductor and switching elements, and the present application is not limited thereto. The input capacitor C_{B} is connected in parallel with the output of the DC power supply module 5 and is used to stabilize the input power (represented by the input voltage Vin). The LLC resonant conversion module 10 is coupled to the input capacitor C_{B} and is used to perform resonant conversion on the input power to generate operating power (represented by the output voltage Vout) supplied to the load LD. The output capacitor CO is connected in parallel at the output of the LLC resonant conversion module 10 and the load LD and is used to stabilize the operating power.

The LLC resonant conversion module 10 in the present embodiment comprises an input switching unit 11, a resonant unit 12, a transformer unit 13, a synchronous rectification unit 14, and a control circuit 15. The input terminal of the input switching unit 11 is coupled to the input capacitor CB to receive the input voltage Vin. The resonant unit 12 is coupled between the output terminal of the input switching unit 11 and the primary winding of the transformer unit 13. The secondary winding of the transformer unit 13 is coupled to the input terminal of the synchronous rectification unit 14. The output terminal of the synchronous rectification unit 14 is coupled to the output capacitor CO. The control circuit 15 is coupled to the control terminals of the input switching unit 11 and the synchronous rectification unit 14.

The resonant unit 12 can comprise a plurality of inductive reactance elements. FIG. 1 illustrates an example comprising a resonant inductor Lr, a resonant capacitor Cr, and a magnetizing inductance Lm contained within the transformer unit 13, but the present application is not limited thereto. In the present embodiment, one end of the resonant inductor Lr is coupled to one output end of the input switching unit 11, one end of the resonant capacitor Cr is coupled to the other end of the resonant inductor Lr, the other end of the resonant capacitor Cr is coupled to one end of the primary winding of the transformer unit 13 and one end of the magnetizing inductance Lm, and the other end of the magnetizing inductance Lm is coupled to the other output end of the input switching unit 11.

Specifically, the control circuit 15 is configured to generate a plurality of input control signals Sc1, Sc2, ..., Scn and synchronous rectification control signals Src1, Src2, ..., Srcn to control the conduction states of the input switching unit 11 and the synchronous rectification unit 14, respectively. This enables the input switching unit 11 to transfer energy to the secondary side of the transformer unit 13 in response to the timing of the received input control signals Sc1~Scn, and the synchronous rectification unit 14, in response to the timing of the received synchronous rectification control signals Src1~Srcn, cooperates with the input switching unit 11 to perform synchronous rectification and generate an output voltage Vout to supply to the load LD. Herein, n can be a positive integer greater than or equal to 2, depending on the specific circuit architectures of the input switching unit 11 and the synchronous rectification unit 14.

In some embodiments, the switching-mode power supply 1 may also comprise a voltage detection unit (not shown) and a current detection unit (not shown) coupled to the output capacitor CO. The control circuit 15 can monitor the output voltage Vout and output current through the voltage detection unit and the current detection unit, respectively, to adjust the input control signals Sc1~Scn and synchronous rectification control signals Src1~Srcn, thereby maintaining the stability of the gain, output voltage, output current, and/or output power of the switching-mode power supply 1. More specifically, in some embodiments, the control circuit 15 monitors the output voltage Vout supplied to the load LD to calculate a target voltage gain, and adjusts the switching frequency of the LLC resonant conversion module based on the target voltage gain.

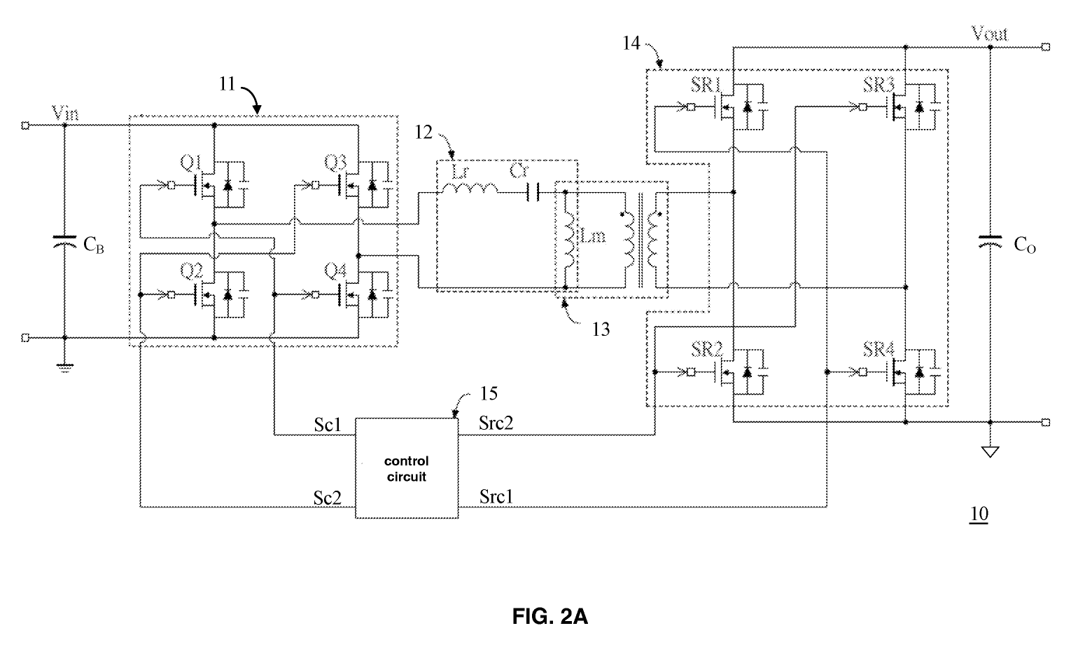

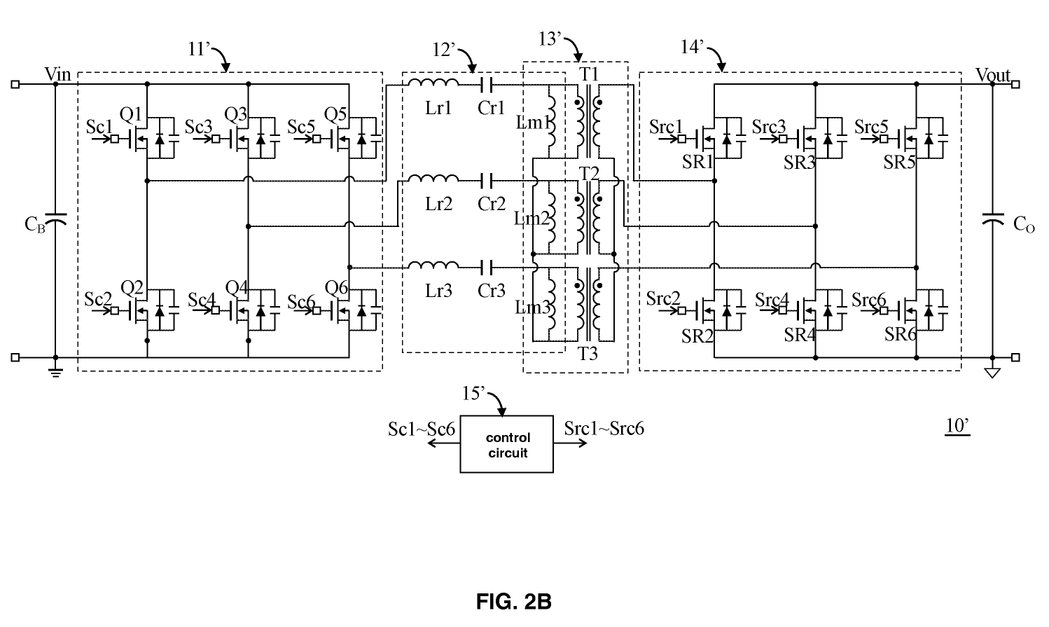

FIGS. 2A and 2B are schematic circuit architecture diagrams of an LLC resonant conversion module according to different embodiments of FIG. 1. Please refer first to FIG. 2A, in the exemplary circuit diagram shown in FIG. 2A, the input switching unit 11 is exemplarily a full-bridge switching unit, which comprises input switching elements Q1~Q4. The input switching elements Q1 and Q2 form a half-bridge circuit, and the input switching elements Q3 and Q4 form another half-bridge circuit; the two half-bridge circuits are connected in parallel. Furthermore, the input switching elements Q1 and Q3 can be referred to as upper-arm switches, and the input switching elements Q2 and Q4 can be referred to as lower-arm switches. In the present embodiment, the connection node of the input switching elements Q1 and Q2 serves as one output end of the input switching unit 11 and is coupled to one end of the resonant inductor Lr, and the connection node of the input switching elements Q3 and Q4 serves as the other output end of the input switching unit 11 and is coupled to the other end of the magnetizing inductance Lm. Herein, the input control signal Sc1 generated by the control circuit 15 is provided to the control terminals of the input switching elements Q1 and Q4, and the input control signal Sc2 generated by the control circuit 15 is provided to the control terminals of the input switching elements Q2 and Q3.

On the other hand, the synchronous rectification unit 14 is exemplarily a full-bridge synchronous rectification unit, which comprises synchronous rectification switching elements SR1~SR4, wherein the synchronous rectification switching elements SR1 and SR2 form a half-bridge circuit, and the synchronous rectification switching elements SR3 and SR4 form another half-bridge circuit; the two half-bridge circuits are connected in parallel. Furthermore, the synchronous rectification switching elements SR1 and SR3 can be referred to as upper-arm switches, and the synchronous rectification switching elements SR2 and SR4 can be referred to as lower-arm switches. In the present embodiment, the connection node of the synchronous rectification switching elements SR1 and SR2 serves as one input end of the synchronous rectification unit 14 and is coupled to one end of the secondary winding of the transformer unit 13, and the connection node of the synchronous rectification switching elements SR3 and SR4 serves as the other input end of the synchronous rectification unit 14 and is coupled to the other end of the secondary winding of the transformer unit 13. Herein, the synchronous rectification control signal Src1 generated by the control circuit 15 is provided to the control terminals of synchronous rectification switching elements SR1 and SR4, and the synchronous rectification control signal Src2 generated by the control circuit 15 is provided to the control terminals of synchronous rectification switching elements SR2 and SR3.

The input control signals Sc1 and Sc2 and the synchronous rectification control signals Src1 and Src2 are all periodic pulse signals. The preset duty cycle for each input control signal Sc1 and Sc2 / synchronous rectification control signal Src1 and Src2 can be, for example but not limited to, 50%. More specifically, under normal operation of the switching-mode power supply 1, input control signals Sc1 and Sc2 are complementary signals, synchronous rectification control signals Src1 and Src2 are complementary signals, and input control signal Sc1 and synchronous rectification control signal Src1 are signals with the same phase.

Next, please refer to FIG. 2B, which primarily illustrates a three-phase LLC resonant conversion module 10' as an example. The three-phase LLC resonant conversion module 10' in the present embodiment comprises an input switching unit 11', a resonant unit 12', a transformer unit 13', a synchronous rectification unit 14', and a control circuit 15'. In the present embodiment, the input switching unit 11' comprises input switching elements Q1~Q6, where input switching elements Q1 and Q2, input switching elements Q3 and Q4, and input switching elements Q5 and Q6 form three sets of half-bridge circuits connected in parallel. Furthermore, input switching elements Q1, Q3, and Q5 can be referred to as upper-arm switches, and input switching elements Q2, Q4, and Q6 can be referred to as lower-arm switches.

The resonant unit 12' comprises resonant inductors Lr1~Lr3 and resonant capacitors Cr1~Cr3. In some embodiments, the resonant unit 12' can also be considered to include magnetizing inductances Lm1~Lm3 contained within transformers T1~T3. The transformer unit 13' comprises transformers T1~T3, which can be, for example, three independent transformers or a three-phase integrated transformer, and the present application is not limited thereto. In the present embodiment, the resonant inductors Lr1~Lr3 and the corresponding series-connected resonant capacitors Cr1~Cr3 form three sets of resonant circuits, respectively coupled between the corresponding output terminals of the input switching unit 11' and the primary windings of the corresponding transformers T1~T3. For example, the resonant inductor Lr1 and the resonant capacitor Cr1 form a set of resonant circuits, one end of which is coupled to the first output terminal of the input switching unit 11', and the other end of which is coupled to one end of the primary winding of transformer T1; other sets of resonant circuits have similar configurations and will not be repeated here.

The connection node of the input switching elements Q1 and Q2 serves as the first output end of the input switching unit 11' and is coupled to one end of the resonant inductor Lr1. The connection node of the input switching elements Q3 and Q4 serves as the second output end of the input switching unit 11' and is coupled to one end of the resonant inductor Lr2. The connection node of the input switching elements Q5 and Q6 serves as the third output end of the input switching unit 11' and is coupled to one end of the resonant inductor Lr3. Herein, the input control signals Sc1~Sc6 generated by the control circuit 15 are respectively provided to the control terminals of input switching elements Q1~Q6.

On the other hand, the circuit configuration of the synchronous rectification unit 14' is similar to that of the input switching unit 11', which includes synchronous rectification switching elements SR1~SR6. The synchronous rectification switching elements SR1~SR6 form three sets of parallel-connected half-bridge circuits. Furthermore, the synchronous rectification switching elements SR1, SR3, and SR5 can be referred to as upper-arm switches, and the synchronous rectification switching elements SR2, SR4, and SR6 can be referred to as lower-arm switches. In the present embodiment, the connection node of the synchronous rectification switching elements SR1 and SR2 serves as the first input end of the synchronous rectification unit 14' and is coupled to one end of the secondary winding of transformer T1. The connection node of the synchronous rectification switching elements SR3 and SR4 serves as the second input end of the synchronous rectification unit 14' and is coupled to one end of the secondary winding of transformer T2. The connection node of the synchronous rectification switching elements SR5 and SR6 serves as the third input end of the synchronous rectification unit 14' and is coupled to one end of the secondary winding of transformer T3. Herein, the synchronous rectification control signals Src1~Src6 generated by the control circuit 15' are respectively provided to the control terminals of the synchronous rectification switching elements SR1~SR6.

In the present embodiment, the input control signals Sc1~Sc6 and the synchronous rectification control signals Src1~Src6 are all periodic pulse signals. The preset duty cycle for each control signal Sc1~Sc6 and Src1~Src6 can be, for example but not limited to, 50%. More specifically, the input control signals Sc1, Sc3, and Sc5 provided to the upper-arm switches of the input switching unit 11' are signals with sequential 120° phase differences, while the corresponding input control signals Sc2, Sc4, and Sc6 for the lower-arm switches are complementary to the input control signals Sc1, Sc3, and Sc5, respectively. The synchronous rectification unit 14' is controlled by the synchronous rectification control signals Src1~Src6 that are synchronized with the input switching unit 11'. Under normal operation of the switching-mode power supply 1, the synchronous rectification control signals Src1~Src6 are signals that have the same phase as the input control signals Sc1~Sc6, respectively.

It should be noted here that although the transformer unit 13' in the present embodiment is illustrated as a three-phase transformer with a Wye-Wye connection (Y-Y connection), the present application is not limited thereto. In other embodiments, the wiring method of the transformer unit 13' can also be implemented with different wiring methods such as Delta-Delta connection (∆-∆), Wye-Delta connection (Y-∆), or Delta-Wye connection (∆-Y).

Additionally, since simultaneous conduction of the upper-arm and the lower-arm switches would lead to a direct short circuit of the input power, causing a large current surge that could damage switching components and/or other electronic components, in actual signal design, a dead time is designed to exist between complementary control signals. That is, the two complementary control signals have a period where they are simultaneously at a disable level (e.g., low level) to prevent simultaneous conduction of upper-arm and lower-arm switches during alternating switching. For simplicity of description in this document, the dead time will be omitted in the subsequent descriptions or signal timings of input control signals/synchronous rectification control signals, as stated herein.

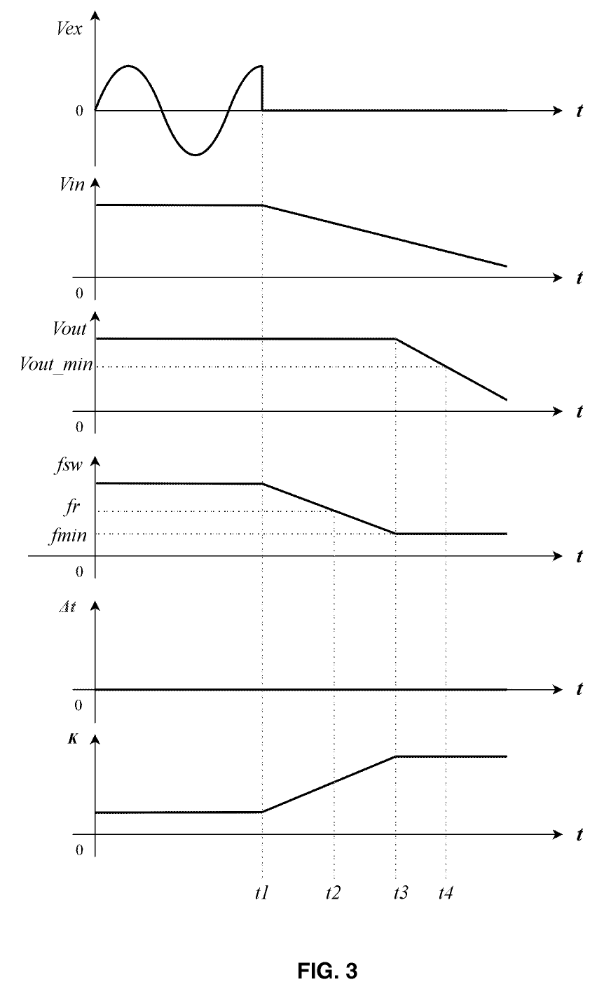

FIG. 3 is a schematic power sequence diagram of a switching-mode power supply. Here, the power sequence of the LLC resonant conversion module 10 illustrated in FIG. 2A will be described. Please refer to FIGS. 2A and 3 simultaneously. The present embodiment illustrates the corresponding control timing when an abnormal condition occurs in the external power source Vex for the switching-mode power supply. When an abnormal condition occurs in the external power source Vex at time point t1 (e.g., power outage, instantaneous interruption, or abnormal undervoltage), the input voltage Vin stored in the input capacitor C_{B} will release energy, which is then transferred to the output via the LLC resonant conversion module 10. This energy transfer process is also accompanied by the consumption of energy within the input capacitor CB, causing the input voltage Vin to decrease over time.

To maintain the output voltage Vout within the rated range, the control circuit 15 adjusts the frequency of the input control signals Sc1 and Sc2 / synchronous rectification control signals Src1 and Src2, so that the switching frequency fsw of the input switching unit 11 and the synchronous rectification unit 14 decreases as the input voltage Vin decreases, thereby increasing the voltage gain K and compensating for the effect caused by the decrease in input energy. In other words, at this stage, the control circuit 15 controls the LLC resonant conversion module 10 in a variable frequency manner.

As the switching frequency fsw gradually decreases, the primary side switching characteristic gradually transitions from the inductive region to the capacitive region. In the capacitive region, the resonant voltage exhibits a phase delay relative to the resonant current (voltage lags current), which will cause the input switching elements Q1~Q4 to encounter high voltage and current stress during switching, potentially leading to component damage.

To avoid this situation, under the control timing of FIG. 3, the control circuit 15 is set to have a minimum limit frequency fmin, so that the switching frequency fsw does not fall below this value to prevent falling into the capacitive region. Therefore, when the switching frequency fsw drops to the minimum limit frequency fmin at time point t3, the LLC resonant conversion module 10 no longer continues to reduce frequency, but maintains the switching frequency fsw at the minimum limit frequency fmin. At this point, the voltage gain K corresponding to the variable frequency control also reaches its maximum value and becomes fixed, as shown in the time segment from time points t3 to t4 in FIG. 3.

If the input voltage Vin continues to decrease (i.e., the external power source Vex remains in an abnormal state), since the voltage gain K can no longer be increased, the output voltage Vout will not be able to be maintained within the rated range and will begin to decrease with the input voltage Vin. Eventually, at time point t4, it will drop to the system's lowest acceptable output voltage Vout_min, at which point the switching-mode power supply 1 cannot continue to maintain normal power supply operation. Therefore, under the control timing of the present embodiment, the hold-up time of the output voltage Vout is the period from time points t1 to t4, which is the period during which the output voltage Vout decreases from the normal operating voltage to the minimum output voltage Vout_min.

Under this control method, once the switching frequency fsw drops to the minimum limit frequency fmin, the output voltage Vout will start to decrease rapidly, thereby limiting the hold-up time. In addition, when the switching frequency fsw drops below the resonant frequency fr of the LLC resonant conversion module 10 (time point t2), if the conduction time of the input switching elements Q1~Q4 is greater than the resonant period (i.e., the inverse of the resonant frequency fr = 1/fr) at this time, the resonant unit 12 will no longer transfer energy to the secondary side, which will indirectly cause the secondary side current to enter discontinuous conduction mode (DCM). If the synchronous rectification switching elements SR1~SR4 on the secondary side remain in a conducting state during periods of no energy transfer, current might flow in reverse through the synchronous rectification switching elements SR1~SR4, and energy from the output capacitor Cout could be fed back to the primary side via the coupling path of the transformer unit 13, which would conversely reduce the overall output voltage gain K.

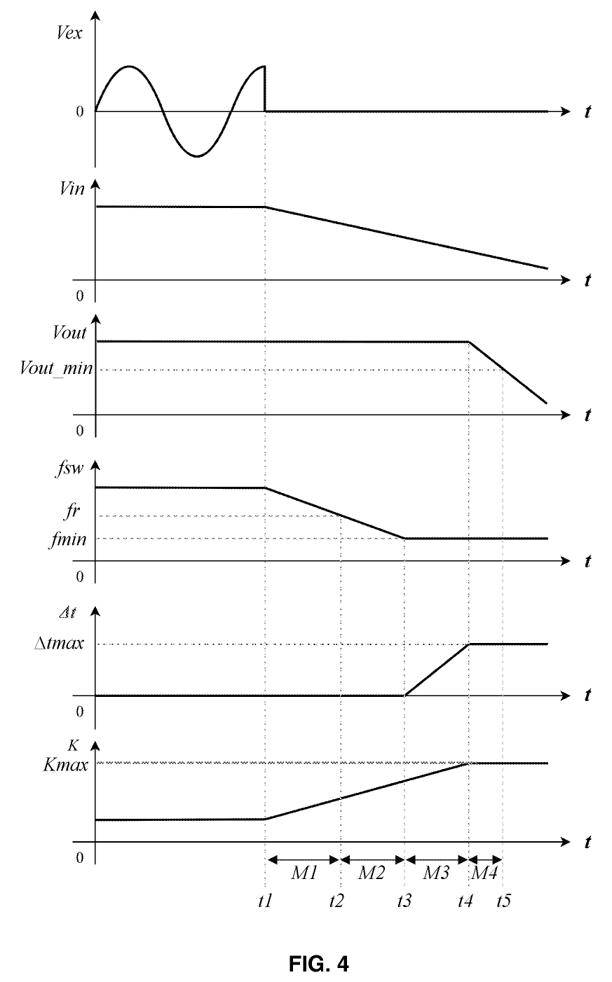

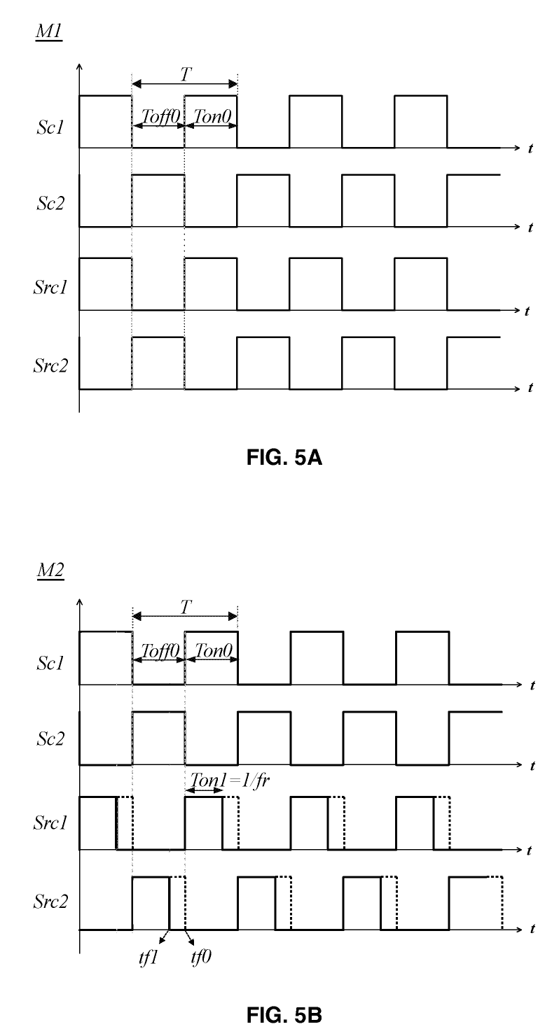

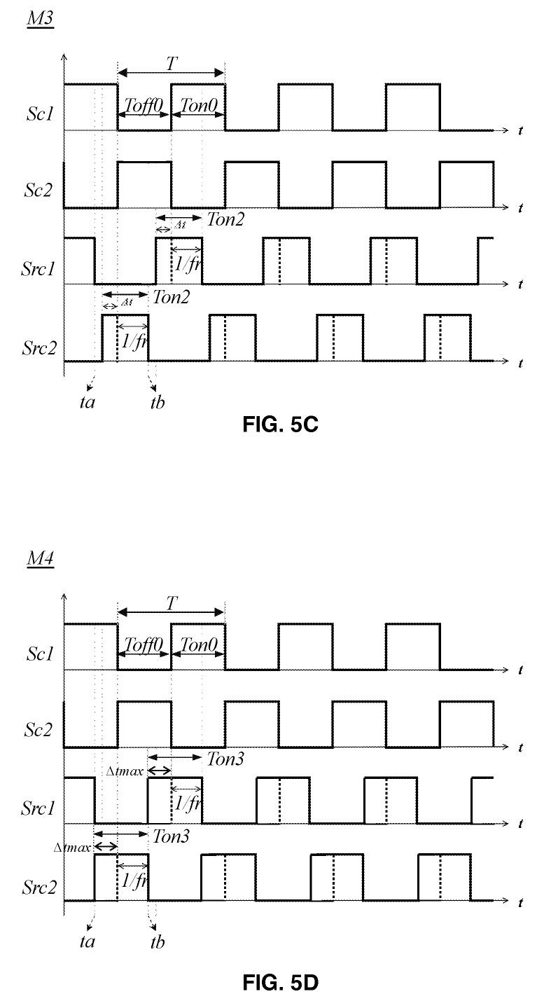

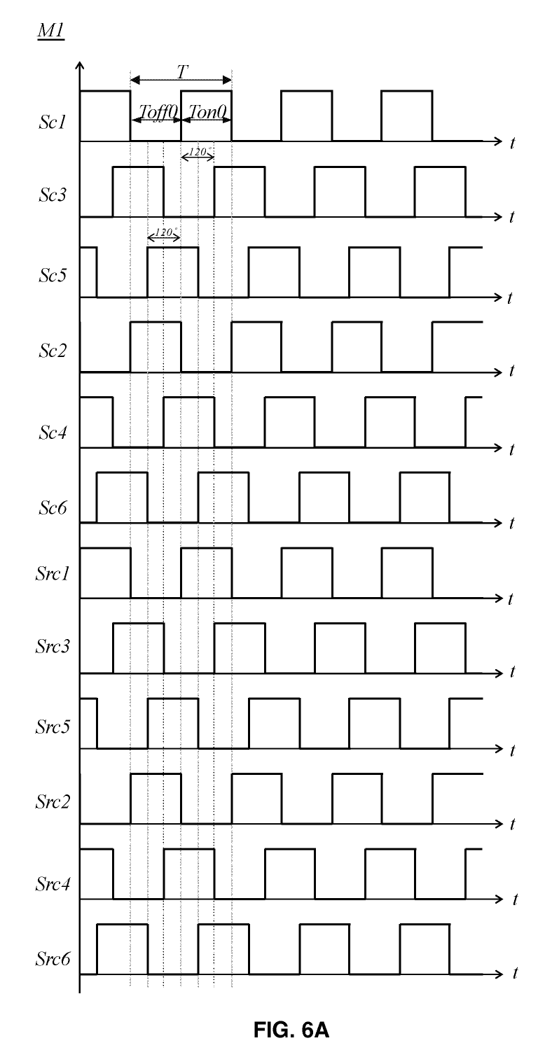

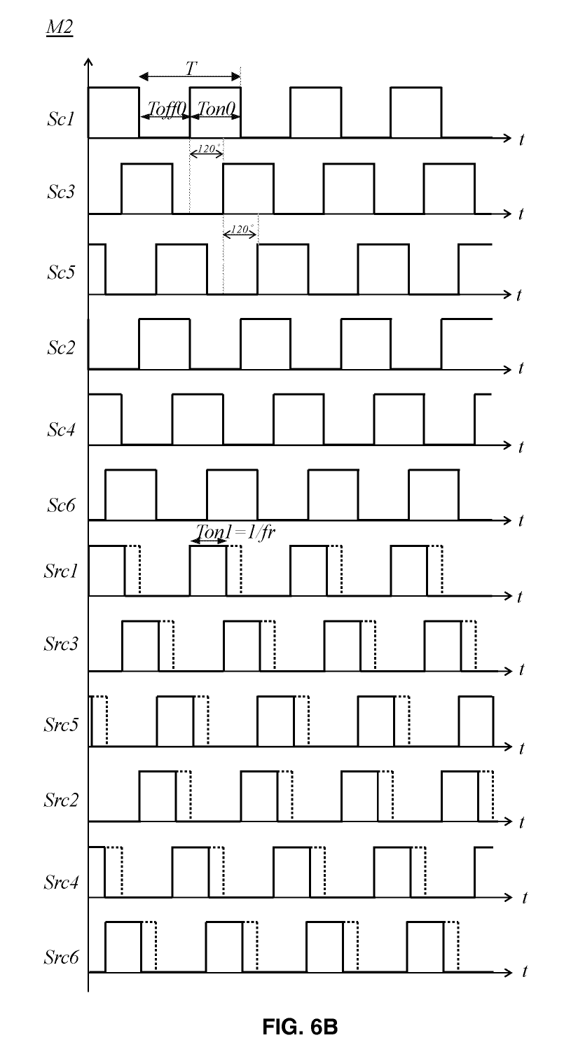

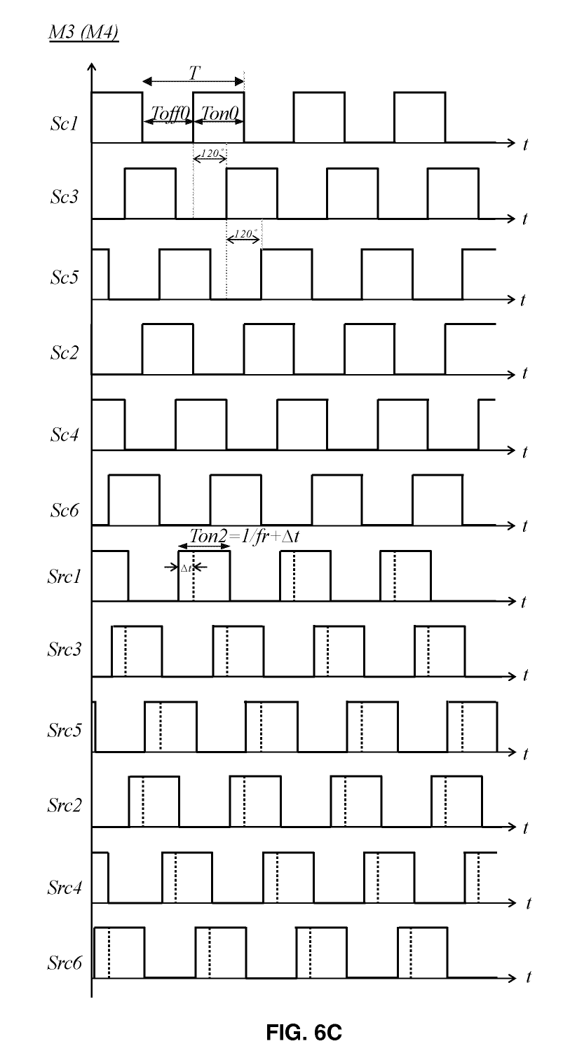

To solve the above problems, the present embodiment proposes a variety of control methods that can further extend the hold-up time and avoid current backflow issues. The power sequence of the first embodiment is shown in FIG. 4, wherein the signal waveforms of the input control signals Sc1 and Sc2 and the synchronous rectification control signals Src1 and Src2 for the LLC resonant conversion module 10 shown in FIG. 2A at different operating stages can be seen in FIGS. 5A-5D. The input control signals Sc1~Sc6 and the synchronous rectification control signals Src1~Src6 for the three-phase LLC resonant conversion module 10' shown in FIG. 2B can be seen in FIGS. 6A-6C.

The control power sequence of the LLC resonant conversion module 10 shown in FIG. 2A will be described. Please refer to the power sequence between time points t1 and t2 in FIGS. 2A and 4, and the control signal waveform in FIG. 5A. In the first operating stage M1, i.e., from when the external power source Vex becomes abnormal (time point t1) until the switching frequency fsw drops to the resonant frequency fr (time point t2), the control circuit 15 will linearly reduce the switching frequency fsw of the input control signals Sc1 and Sc2 and the synchronous rectification control signals Src1 and Src2 according to a specific ratio/slope as the input voltage Vin drops. In the first operating stage M1, the period of each control signal Sc1, Sc2, Src1, and Src2 is T, in which the enable (ON) period is Ton0 and the disable (OFF) period is Toff0. In other words, the duty cycle of each control signal Sc1, Sc2, Src1, and Src2 is Ton0/T.

When the switching frequency fsw drops below the resonant frequency fr, the LLC resonant conversion module 10 enters the second operating stage M2, as shown by the power sequence between time points t2 and t3 in FIG. 2A and FIG. 4, and the control signal waveform in FIG. 5B. Before the switching frequency fsw drops to the minimum limit frequency fmin (time point t3), the control circuit 15 will reduce the duty cycle of the synchronous rectification control signals Src1 and Src2 from Ton0/T to Ton1/T, wherein the enable period Ton1 is the inverse of the resonant frequency fr (Ton1=1/fr). Through the control method of the second operating stage M2, the conduction time of the synchronous rectification switching elements SR1~SR4 will be maintained at 1/fr, which can then prevent issues of false conduction and energy feedback from the secondary side synchronous rectification switching elements SR1~SR4.

In some embodiments, the control circuit 15 reduces the duty cycle by advancing the falling edge trigger points of the synchronous rectification control signals Src1 and Src2. That is, the falling edge trigger point is advanced from tf0 to tf1.

When the switching frequency fsw drops to the minimum limit frequency fmin, the LLC resonant conversion module 10 enters the third operating stage M3, as shown by the power sequence between time points t3 and t4 in FIGS. 2A and 4, and the control signal waveform in FIG. 5C. The control circuit 15 adjusts the synchronous rectification control signals Src1 and Src2, causing the synchronous rectification switching elements SR1 and SR4 (or SR2 and SR3) to enter the conduction state earlier. More specifically, the enable period of the synchronous rectification control signals Src1 and Src2 in each cycle will be extended from Ton1 to Ton2, thereby extending the conduction period of the synchronous rectification switching elements SR1~SR4 and creating an overlapping enable period Δt between the primary and secondary side switching signals. By appropriately extending the conduction period, the corresponding switching elements on the primary and secondary sides are simultaneously turned on, which can effectively improve the transmission efficiency of the residual energy from the input capacitor C_{B} to the output, thereby increasing the voltage gain that the system can provide at the moment when the input voltage Vin disappears, achieving the technical effect of extending the output voltage Vout hold-up time.

In some embodiments, the control circuit 15 extends the conduction time of the synchronous rectification switching element SR1 by advancing the rising edge trigger points of the synchronous rectification control signals Src1 and Src2 by an extended enable period Δt. Furthermore, in some embodiments, the rising edge trigger time of synchronous rectification control signal Src1 is advanced such that the enable periods of input control signal Sc2 and the synchronous rectification control signal Src1 at least partially overlap; and the rising edge trigger time of synchronous rectification control signal Src2 is advanced such that the enable periods of input control signal Sc1 and the synchronous rectification control signal Src2 at least partially overlap.

To prevent the synchronous rectification control signals Src1 and Src2 on the second side from overlapping excessively and leading to false conduction, the control circuit 15 in the present embodiment limits the maximum increment of the extended enable period Δt to a range not exceeding ta and tb. This prevents signal overlap between the extended conduction intervals of the synchronous rectification switching elements SR1 and SR4 and the other set of synchronous rectification switching elements SR2 and SR3, ensuring the independence and control precision of the switching timing. In other words, in the present embodiment, the rising edge trigger point of the synchronous rectification control signal Src1 is not earlier than the falling edge trigger point of the synchronous rectification control signal Src2 in the same cycle, and not later than the falling edge trigger point of the input control signal Sc2 in the same cycle.

Therefore, after the extended enable period Δt reaches the maximum extended period Δtmax, the LLC resonant conversion module 10 enters the fourth operating stage M4, as shown by the power sequence after time point t4 in FIGS. 2A and 4, and the control signal waveform in FIG. 5D. During this period, the control circuit 15 maintains the enable period of the synchronous rectification control signals Src1 and Src2 in each cycle at Ton3 (=1/fr+Δtmax). At this point, the maximum compensable voltage gain Kmax is reached. Subsequently, if the input voltage Vin continues to decrease, the output voltage Vout will also gradually decrease until it finally decreases to the system's lowest acceptable output voltage Vout_min, at which point the switching-mode power supply 1 cannot continue to maintain normal power supply operation. Therefore, under the control timing of the present embodiment, the hold-up time of the output voltage Vout is the period from time points t1 to t5.

The control timing of the three-phase LLC resonant conversion module 10' shown in FIG. 2B in the first embodiment is as shown in FIGS. 6A-6C. The present embodiment is substantially the same as the aforementioned control method of FIGS. 5A-5D, with the only difference being that the signal modulation method in each operating stage M1~M4 in the present embodiment applies simultaneously to all synchronous rectification control signals Src1~Src6.

For example, in the embodiment of FIGS. 6A-6C, the signal modulation method for the synchronous rectification control signals Src1 and Src2 in each operating stage M1~M4 is essentially the same as that described for the synchronous rectification control signals Src1 and Src2 in FIGS. 5A-5D. The synchronous rectification control signals Src3 and Src4 can be regarded as signals obtained by applying a 120° phase delay to the synchronous rectification control signals Src1 and Src2; and the synchronous rectification control signals Src5 and Src6 can be regarded as signals obtained by applying a 120° phase delay to the synchronous rectification control signals Src3 and Src4. Therefore, the similar and identical aspects can be referred to the descriptions of the aforementioned FIGS. 5A-5D embodiments, and will not be repeated here.

Compared with the power sequences of FIGS. 3 and 4, it can be clearly observed that the present embodiment effectively increases the hold-up time of the output voltage by controlling the extension of the conduction time of the synchronous rectification switching elements SR1~SR4 (or SR1~SR6) after the switching frequency fsw drops to the minimum limit frequency fmin. Specific experimental results indicate that, compared with a switching-mode power supply not adopting the control method of the present embodiment, the control method of the present embodiment can lead to an increase in hold-up time of about 33%.

It should be noted here that although the signal timings in the above embodiments omit the consideration of dead time, in actual design applications, there can be a fixed dead time between the complementary input control signals Sc1~Sc6 / synchronous rectification control signals Src1~Src6. For example, a dead time can exist between the input control signals Sc1 and Sc2 during which both are not conducting (i.e., the duty cycle of one of input control signals Sc1 and Sc2 will be slightly less than the other). In this case, in the third operating stage M3 of the present embodiment, when the control circuit 15/15' calculates the initial extended enable period Δt, it will use the dead time as a base modulation amount and add an additional enable period on top of it to ensure that there is partial overlap in the enable period between the synchronous rectification control signal Src1 and the input control signal Sc2, thereby effectively increasing the voltage gain. Compared to the general control methods that increase voltage gain by adjusting the phase of the synchronous rectification control signals Src1~Src6, the control method of the present embodiment can effectively solve the problem of insufficient voltage gain compensation during the initial period of entering this operating stage.

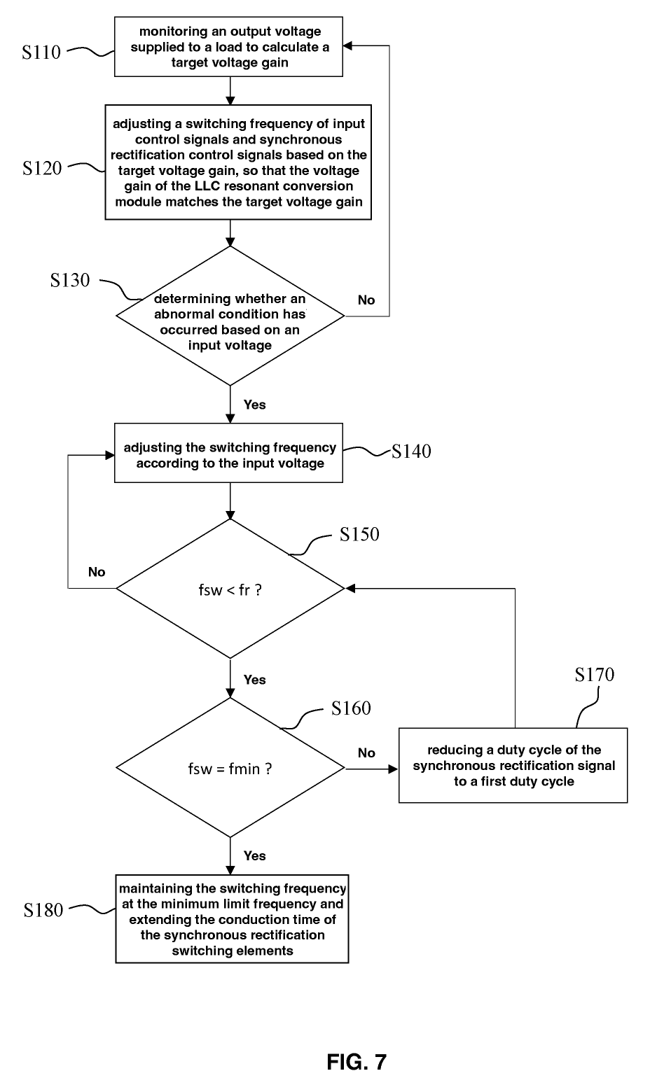

FIG. 7 is a flowchart of a control method for increasing voltage hold-up time of a switching-mode power supply according to some embodiments of the present application. The control method can be used in conjunction with the switching-mode power supply 1 of FIG. 1 and its LLC resonant conversion module 10 of FIG. 2A or the three-phase LLC resonant conversion module 10' of FIG. 2B. The power control timing and control signal timing sequence of the FIG. 9A embodiment's control method can refer to the descriptions of the aforementioned FIGS. 4, 5A-5D, and 6A-6C embodiments, and the power control timing and control signal timing sequence of the FIG. 9B embodiment's control method can refer to the descriptions of the aforementioned FIGS. 4B, 6A-6D, and 8A-8C embodiments. Repetitions will not be reiterated here.

Please refer to FIG. 7, in the control method of the present embodiment, it comprises the following steps: monitoring an output voltage (e.g., Vout) supplied to a load (e.g., LD) to calculate a target voltage gain (Step S110); adjusting a switching frequency (e.g., fsw) of multiple input control signals (e.g., Sc1~Sc6) and multiple synchronous rectification control signals (e.g., Src1~Src6) based on the target voltage gain, so that the voltage gain (e.g., K) of the LLC resonant conversion module (e.g., 110 or 110') matches the target voltage gain (Step S120); determining whether an abnormal condition is present in the external power source (e.g., Vex) based on an input voltage (e.g., Vin) (Step S130); when the external power source (e.g., Vex) is determined to be abnormal, reducing the switching frequency based on the input voltage, such that the voltage gain increases as the input voltage decreases (Step S140); determining whether the switching frequency is lower than a resonant frequency (e.g., fr) (Step S150); determining whether the switching frequency has reached a minimum limit frequency (Step S170); when the switching frequency is lower than the resonant frequency but has not yet reached the minimum limit frequency (e.g., fmin), reducing a duty cycle of the first synchronous rectification signal (e.g., Src1) and the second synchronous rectification control signal (e.g., Src2) to a first duty cycle (Step S170); and when the switching frequency is reduced to the minimum limit frequency, maintaining the switching frequency at the minimum limit frequency, and extending the conduction time of the synchronous rectification switching elements (e.g., SR1~SR6), so that the voltage gain increases in response to the decrease in input voltage (Step S180).

Through the control methods described above, when the external power source Vex experiences a power outage or abnormal power supply, the voltage hold-up time of the output voltage can be effectively extended. This allows the load device (such as a server) to perform data storage and/or backup before the output voltage drops below the minimum output voltage required for the load device's operation.

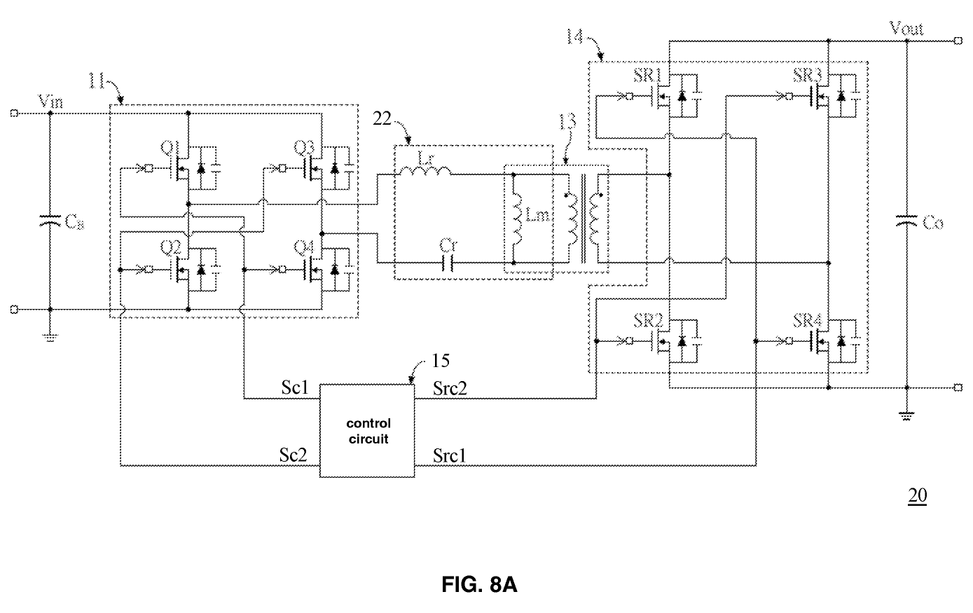

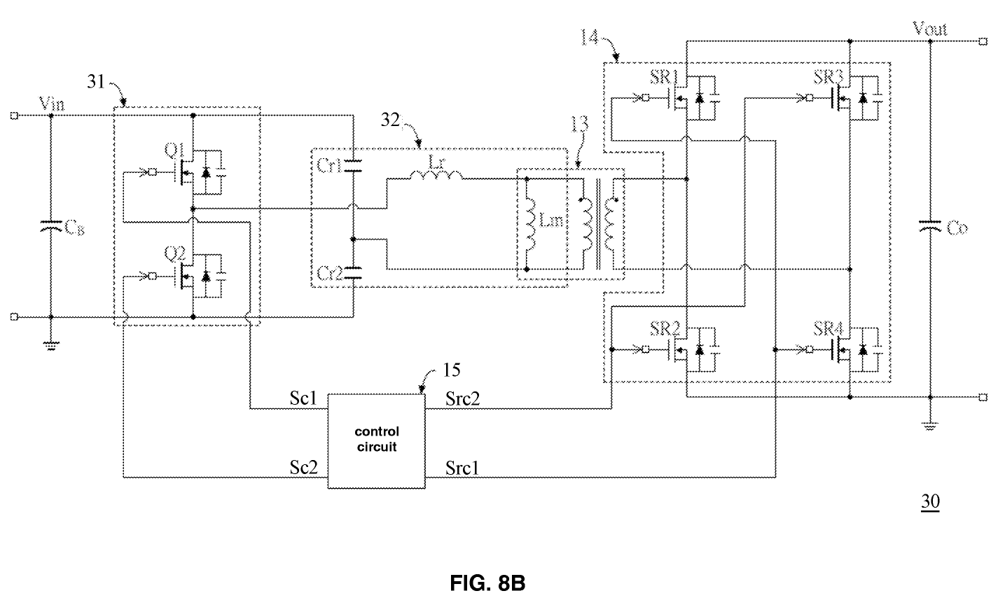

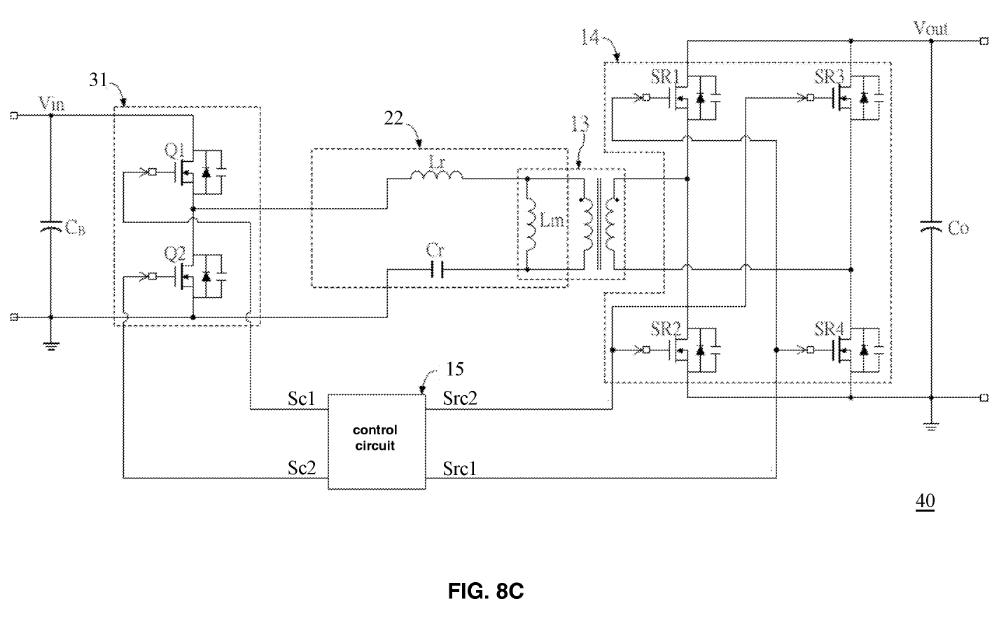

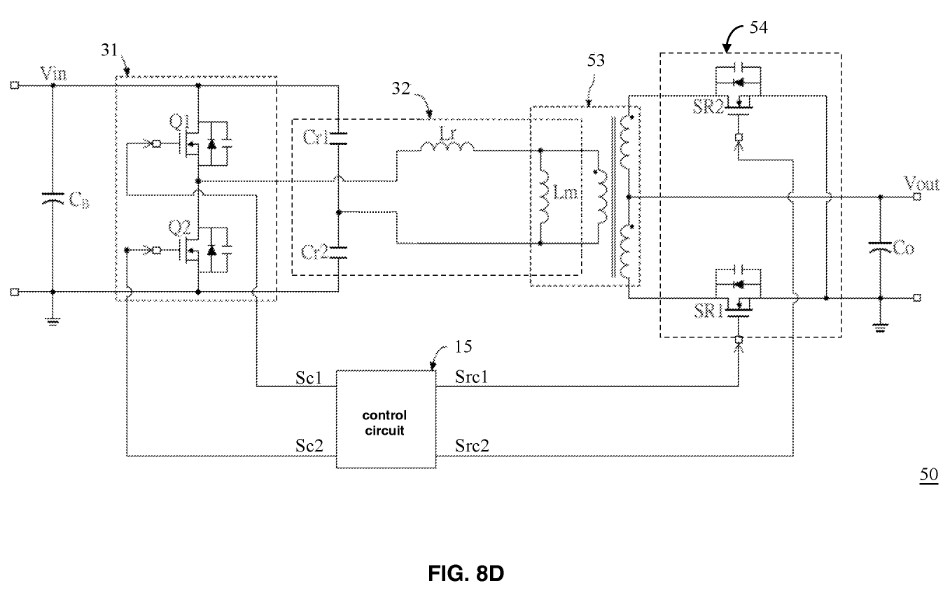

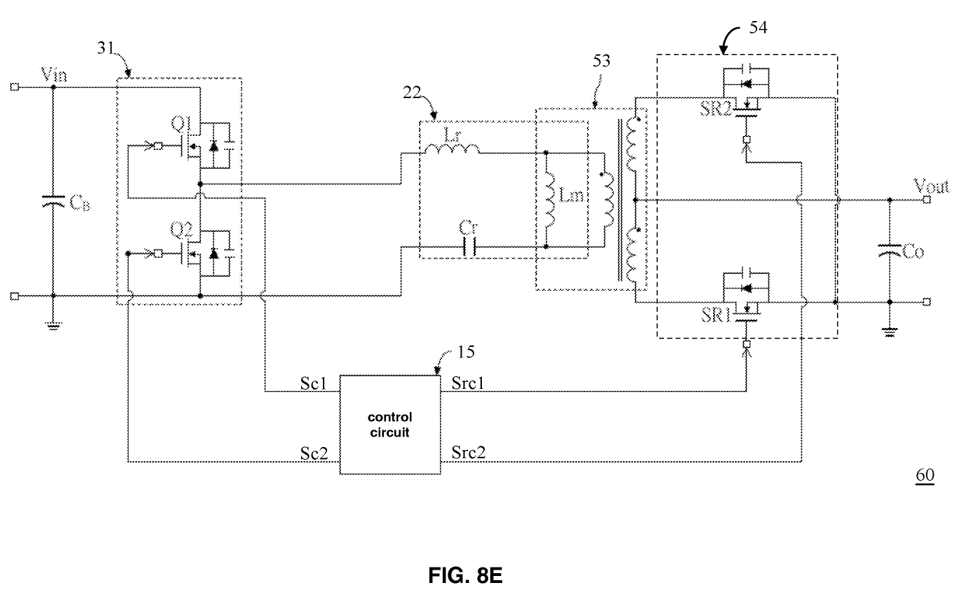

Hereinafter, the circuit architecture diagrams of LLC resonant conversion modules according to different embodiments of the present application will be further explained with reference to FIGS. 8A-8E. The described control methods can be applied to the architecture of each of the following embodiments to further increase the voltage hold-up time.

Please refer first to FIG. 8A. The LLC resonant conversion module 20 of the present embodiment is substantially the same as the LLC resonant conversion module 10 of the aforementioned FIG. 2A embodiment. Its main difference lies in the resonant unit 22 of the present embodiment. Specifically, the resonant unit 22 of the present embodiment comprises a resonant inductor Lr, a resonant capacitor Cr, and a magnetizing inductance Lm of the transformer unit 13. One end of the resonant inductor Lr is coupled to one output end of the input switching unit 11, and the other end of the resonant inductor Lr is coupled to one end of the magnetizing inductance Lm and one end of the primary winding of the transformer unit 13. One end of the resonant capacitor Cr is coupled to the other output end of the input switching unit 11, and the other end of the resonant capacitor Cr is coupled to the other end of the magnetizing inductance Lm and the other end of the primary winding of the transformer unit 13. In other words, the resonant inductor Lr and the resonant capacitor Cr are connected in parallel.

Please refer to FIG. 8B. The LLC resonant conversion module 30 of the present embodiment is substantially the same as the LLC resonant conversion module 10 of the aforementioned FIG. 2A embodiment. Its main differences lie in the input switching unit 31 and the resonant unit 32 of the present embodiment. Specifically, the input switching unit 31 of the present embodiment is a half-bridge switching unit, which comprises an input switching element Q1 (i.e., upper-arm switch) controlled by input control signal Sc1 and an input switching element Q2 (i.e., lower-arm switch) controlled by input control signal Sc2.

The resonant unit 32 of the present embodiment comprises a resonant inductor Lr, resonant capacitors Cr1 and Cr2, and a magnetizing inductance Lm. The resonant capacitors Cr1 and Cr2 are connected in series with each other and in parallel with the half-bridge circuit formed by input switching elements Q1 and Q2. One end of the resonant inductor Lr is coupled to one output end of the input switching unit 11, and the other end of the resonant inductor Lr is coupled to one end of the magnetizing inductance Lm and one end of the primary winding of the transformer unit 13. The connection node of resonant capacitors Cr1 and Cr2 is coupled to the other end of the magnetizing inductance Lm and the other end of the primary winding of the transformer unit 13.

Please refer to FIG. 8C. The LLC resonant conversion module 40 of the present embodiment is substantially the same as the LLC resonant conversion module 20 of the aforementioned FIG. 8A embodiment. Its main difference lies in the input switching unit 31 of the present embodiment being a half-bridge switching unit. Furthermore, compared to the FIG. 8A embodiment, the resonant capacitor Cr of the present embodiment is also coupled to a ground terminal.

Please refer to FIG. 8D. The LLC resonant conversion module 50 of the present embodiment is substantially the same as the LLC resonant conversion module 30 of the aforementioned FIG. 8B embodiment. Its main differences lie in the transformer unit 53 and synchronous rectification unit 54 of the present embodiment. Specifically, the transformer unit 53 is, for example, a center-tapped transformer, which comprises a primary winding, a first secondary winding, and a second secondary winding, and also comprises a magnetizing coil Lm connected in parallel with the primary winding. The synchronous rectification unit 54 of the present embodiment is a half-bridge rectification unit, which comprises a synchronous rectification switching element SR1 (i.e., upper-arm switch) controlled by a synchronous rectification control signal Src1 and a synchronous rectification switching element SR2 (i.e., lower-arm switch) controlled by a synchronous rectification control signal Src2.

Please refer to FIG. 8E. The LLC resonant conversion module 60 of the present embodiment is substantially the same as the LLC resonant conversion module 50 of the aforementioned FIG. 8D embodiment. Its main difference lies in the resonant unit 22 of the present embodiment adopting a configuration similar to FIG. 8A. Other parts can refer to the relevant descriptions of the aforementioned embodiments and will not be repeated here.

It is noted that FIGS. 8A-8E are described based on the architecture of the single-phase LLC resonant conversion module 10 as illustrated in FIG. 2A, to explain various possible modified embodiments. However, a person having ordinary skill in the art, upon considering the embodiments shown in FIGS. 8A-8E, would readily understand how similar circuit modifications can be applied to the three-phase LLC resonant conversion module 10′ as illustrated in FIG. 2B. Accordingly, the related embodiments and circuit architectures should also fall within the scope sufficiently disclosed by the present disclosure.

In summary, the switching-mode power supply and its control method for increasing voltage hold-up time according to the embodiments of the present application have been fully and clearly described. It should be understood that the present application is not limited to the above-described embodiments, and various changes can be made within the scope shown in the claims. Embodiments obtained by appropriately combining technical means disclosed separately in different embodiments are also included within the technical scope of this disclosure. Furthermore, new technical features can be formed by combining the technical means separately disclosed in each embodiment.

Additionally, it should be noted that any numerical values mentioned in this application are not intended to limit the present invention to be realized only at that specified value. The person having ordinary skill in the art should understand that acceptable errors exist for each numerical value/composition ratio. Any value approximately close to the disclosed numerical range is considered to be within the scope disclosed by the present invention, as long as it does not significantly affect the results/functions intended to be achieved by each embodiment.

What is claimed is:

1. A switching-mode power supply adapted to generate an operating power from an external power source for supplying to a load, the switching-mode power supply comprising:
an input capacitor; and
an LLC resonant conversion module coupled to the input capacitor, configured to perform resonant conversion based on the external power source to generate the operating power, wherein the LLC resonant conversion module comprises:
an input switching unit, configured to receive a direct current (DC) power derived from the external power source;
a resonant unit coupled to the input switching unit;
a transformer unit having a primary winding and a secondary winding, wherein the primary winding is coupled to the resonant unit;
a synchronous rectification unit coupled to the secondary winding, configured to perform synchronous rectification in association with the input switching unit; and
a control circuit coupled to the input switching unit and the synchronous rectification unit, configured to monitor an input voltage on the input capacitor to determine whether an abnormal condition is present in the external power source, and accordingly controls conduction states of the input switching unit and the synchronous rectification unit, wherein:
in response to the external power source being determined to be abnormal, the control circuit reduces a switching frequency of the input switching unit and the synchronous rectification unit at a first rate of change, thereby increasing a voltage gain of the LLC resonant conversion module as the input voltage decreases; and
in response to the switching frequency being reduced to a minimum limit frequency, the control circuit maintains the switching frequency at the minimum limit frequency and increases the voltage gain as the input voltage decreases by extending a conduction time of the synchronous rectification unit.

2. The switching-mode power supply of claim 1, wherein the control circuit is further configured to determine whether the switching frequency is lower than a resonant frequency of the switching-mode power supply, and, in response to the switching frequency being lower than the resonant frequency but not yet reduced to the minimum limit frequency, to adjust the conduction time of the synchronous rectification unit based on the resonant frequency.

3. The switching-mode power supply of claim 2, wherein in response to the switching frequency being lower than the resonant frequency but not yet reduced to the minimum limit frequency, the control circuit fixes the conduction time of the synchronous rectification unit to a first conduction time, the first conduction time being an inverse of the resonant frequency.

4. The switching-mode power supply of claim 3, wherein in response to the switching frequency being reduced to the minimum limit frequency, the control circuit extends the conduction time of the synchronous rectification unit from the first conduction time to a second conduction time such that the input switching unit and the synchronous rectification unit are concurrently turned on for at least a portion of time.

5. The switching-mode power supply of claim 1, wherein the input switching unit comprises a plurality of input switching elements and the synchronous rectification unit comprises a plurality of synchronous rectification switching elements; the control circuit is configured to generate a first control signal and a second control signal that are complementary to each other to control the plurality of input switching elements, and to generate a first synchronous rectification control signal and a second synchronous rectification control signal that are complementary to each other to control the plurality of synchronous rectification switching elements.

6. The switching-mode power supply of claim 5, wherein in response to the switching frequency being lower than a resonant frequency of the switching-mode power supply but not yet reduced to the minimum limit frequency, the control circuit reduces duty cycles of the first synchronous rectification control signal and the second synchronous rectification control signal to a first duty cycle, wherein an enabling period corresponding to the first duty cycle is an inverse of the resonant frequency.

7. The switching-mode power supply of claim 6, wherein the control circuit reduces the duty cycles by advancing falling edge trigger timings of the first synchronous rectification control signal and the second synchronous rectification control signal.

8. The switching-mode power supply of claim 5, wherein in response to the switching frequency being reduced to the minimum limit frequency, the control circuit advances rising edge trigger timings of the first synchronous rectification control signal and the second synchronous rectification control signal such that conduction times of the plurality of synchronous rectification switching elements are extended.

9. The switching-mode power supply of claim 8, wherein the rising edge trigger timing of the first synchronous rectification control signal is advanced such that enabling periods of the second control signal and the first synchronous rectification control signal at least partially overlap, and the rising edge trigger timing of the second synchronous rectification control signal is advanced such that enabling periods of the first control signal and the second synchronous rectification control signal at least partially overlap.

10. The switching-mode power supply of claim 9, wherein the rising edge trigger timing of the first synchronous rectification control signal is no earlier than a falling edge trigger timing of the second synchronous rectification control signal within a same cycle, and no later than a falling edge trigger timing of the second control signal within the same cycle.

11. The switching-mode power supply of claim 10, wherein the rising edge trigger timing of the second synchronous rectification control signal is no earlier than a falling edge trigger timing of the first synchronous rectification control signal within the same cycle, and no later than the falling edge trigger timing of the second control signal within the same cycle.

12. The switching-mode power supply of claim 10, wherein the control circuit is further configured to monitor an output voltage supplied to the load to calculate a target voltage gain, and to adjust the switching frequency based on the target voltage gain.

13. A control method for extending a voltage hold-up time of a switching-mode power supply, wherein the switching-mode power supply is adapted to generate an operating power from an external power source for supplying to a load and comprising an LLC resonant conversion module, the control method comprising:
monitoring an output voltage supplied to the load to calculate a target voltage gain;
adjusting a switching frequency of a first input control signal and a second input control signal and a first synchronous rectification control signal and a second synchronous rectification control signal based on the target voltage gain such that a voltage gain of the LLC resonant conversion module matches the target voltage gain, wherein the first input control signal and the second input control signal are complementary to each other and configured to control operations of a plurality of input switching elements of the LLC resonant conversion module, and the first synchronous rectification control signal and the second synchronous rectification control signal are complementary to each other and configured to control operations of a plurality of synchronous rectification switching elements of the LLC resonant conversion module;
determining, based on an input voltage, whether the external power source is abnormal;
in response to the external power source being determined to be abnormal, adjusting the switching frequency according to the input voltage such that the voltage gain increases as the input voltage decreases;
determining whether the switching frequency is lower than a resonant frequency and whether the switching frequency has reached a minimum limit frequency lower than the resonant frequency;
in response to the switching frequency being lower than the resonant frequency but not yet reduced to the minimum limit frequency, reducing duty cycles of the first synchronous rectification control signal and the second synchronous rectification control signal to a first duty cycle, wherein an enabling period corresponding to the first duty cycle is an inverse of the resonant frequency; and
in response to the switching frequency being reduced to the minimum limit frequency, maintaining the switching frequency at the minimum limit frequency and advancing rising edge trigger timings of the first synchronous rectification control signal and the second synchronous rectification control signal such that conduction times of the plurality of synchronous rectification switching elements are extended.

14. The control method of claim 13, wherein the duty cycles are reduced by advancing falling edge trigger timings of the first synchronous rectification control signal and the second synchronous rectification control signal.
